(19) United States
(12) Patent Application Publication
(10) Pub. No.: US 2008/0074077 A1
(43) Pub. Date: Mar. 27, 2008

(54) SYSTEM OF SUPPLYING POWER BETWEEN PORTABLE DEVICES AND PORTABLE DEVICE USED THEREIN

(75) Inventors: SHIH-FANG WONG, Tu-Cheng (TW); YI-FENG WENG, Shenzhen (CN); YONG YUAN, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HONG FU JIN PRECISION INDUSTRY (ShenZhen) CO., LTD ., ShenZhen City (CN)

(21) Appl. No.: 11/829,101

(22) Filed: Jul. 27, 2007

(30) Foreign Application Priority Data
Sep. 22, 2006 (CN) 200610062733.3

(51) Int. Cl. H02J 7/00; H02J 7/02

(52) U.S. Cl. 320/103; 320/128

(57) ABSTRACT

A system of supplying power between portable devices includes a power providing portable device and a power receiving portable device. The power providing portable device includes a rechargeable battery, a voltage regulator, a voltage selector, and an output port. The voltage regulator is used for regulating output voltage from the rechargeable battery according to the voltage selector and transmitting the power via the output port to the power receiving portable device. The power receiving portable device includes an input port for receiving power from the providing device and transmitting power to a rechargeable battery of the receiving device. A portable device used in the system for either receiving or supplying power is also disclosed in the invention.

### BACKGROUND

1. Technical Field

The present invention relates to a system of supplying power between portable devices and the portable devices for receiving or supplying power.

2. General Background

Nowadays electronic products (e.g., mobile phone, mp3, digital camera and so on) are ubiquitous and each type of these electronic products often comes with the applicable battery charger. However, battery chargers are not interchangeable. As such, it would be helpful, if an electronic product battery can be recharged with a battery charger of another electronic product.

Different types of the electronic products have different voltage requirements and function under different working voltages. If the electronic product is charged under abnormal voltages, it may malfunction or even damage. So the need exists for an electronic product that is able to charge or re-charge other electronic products with different voltage requirements.

Therefore, a heretofore need exists in the industry to overcome the aforementioned limitations.

### SUMMARY

A system of supplying power between portable devices includes a power providing portable device and a power receiving portable device. The power providing portable device includes a rechargeable battery, a voltage regulator, a voltage selector, and an output port. The voltage regulator is used for regulating power from the rechargeable battery according to the voltage selector and transmitting the power via the output port to the power receiving portable device. The power receiving portable device includes an input port for receiving power from the providing device and transmitting power to a rechargeable battery of the receiving device.

A first portable device includes a rechargeable battery; an output port for outputting power from the rechargeable battery; a voltage selector for receiving a voltage selection of a desired output voltage of the portable device; and a voltage regulator for regulating the power from the rechargeable battery according to the voltage selection before outputting the power via the output port. Instead of the input port and the output port of the first portable device depicted above, a second portable device includes a power port; a switching unit for connecting either the rechargeable battery or the voltage regulator to the power port; and a charge/discharge selector for controlling the switching unit.

Other advantages and novel features will be drawn from the following detailed description with reference to the attached drawings.

### BRIEF DESCRIPTION OF THE DRAWINGS

FIG. 1 depicts an exemplary block diagram of a system in accordance with a preferred embodiment of the present invention;

FIG. 2 depicts an exemplary block diagram of a first portable device which can be employed in the system of FIG. 1; and

FIG. 3 depicts an exemplary block diagram of a second portable device which can be employed in the system of FIG. 1.

### DETAILED DESCRIPTION OF THE EMBODIMENT

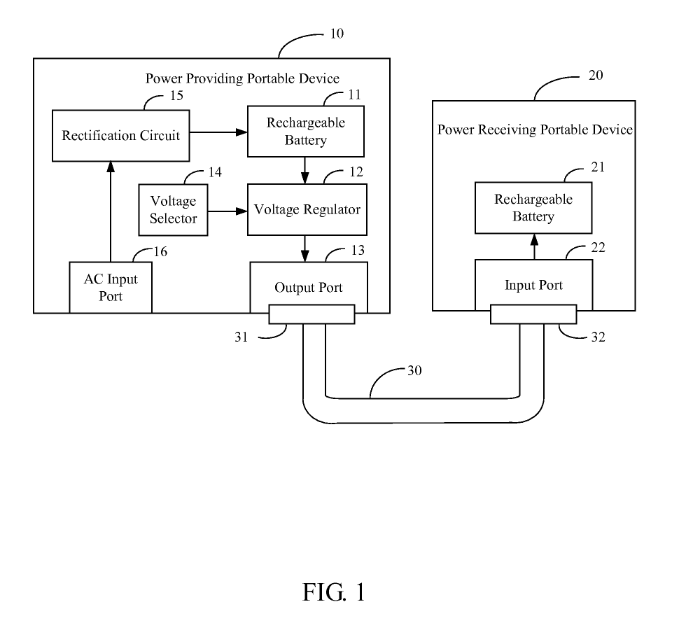

FIG. 1 is an exemplary block diagram of a system of supplying power between portable devices in accordance with a preferred embodiment of the present invention. The system of supplying power between the portable devices (hereinafter “the system”) includes a power providing portable device (hereinafter “the providing device”) 10 and a power receiving portable device (hereinafter “the receiving device”) 20. The providing device 10 is connected with the receiving device 20 by a cable 30 that includes plug 31, 32 on each end. The providing device 10 includes an output port 13 configured to receive the plug 31, and the receiving device 20 includes an input port 23 configured to receive the plug 32. The cable 30 transmits power from the output port 13 to the input port 22.

The providing device 10 further includes a voltage regulator 12 that is connected with the output port 13 and a rechargeable battery 11 of the providing device 10. The voltage regulator 12 is controlled by a voltage selector 14 which is provided to receive a voltage selection according to a desired output voltage of the providing device 10. The voltage regulator obtains power from the rechargeable battery 11 and regulates the power according to the voltage selection of the voltage selector 14. For example, if three output voltages 4V, 5V, and 12V are selectable by the voltage selector 14, the desired output voltage can be selected from either of the three output voltages 4V, 5V, and 12V via the voltage selector 14 according to different receiving devices 20. The providing device 10 then outputs the power at the desired output voltage of either of output voltages 4V, 5V, or 12V to charge the receiving device 20.

The providing device 10 further includes a rectification circuit 15 and an alternating current (AC) input port 16. The AC input port 16 connects with an AC source and transmit power to the rectification circuit 15. The rectification circuit 15 rectifies the power and then supplies a direct current to the rechargeable battery 11 for charging the providing device 10.

The receiving device 20 includes an input port 22 and a rechargeable battery 21. The input port 22 obtains power from the providing device 10 to the rechargeable battery 21 for charging the receiving device 20.

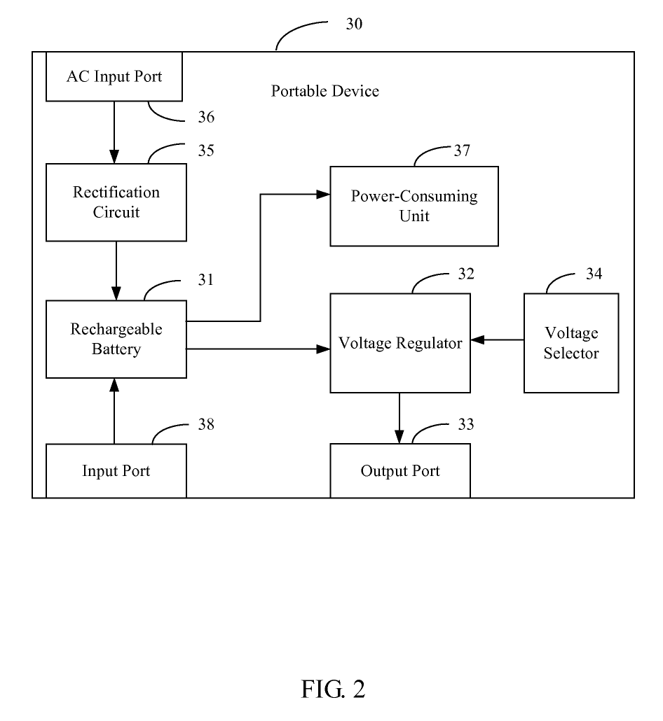

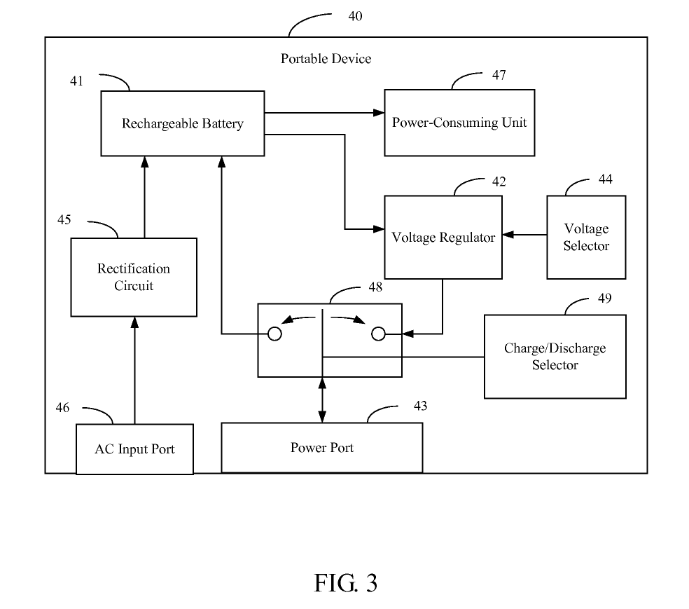

As depicted above, the providing device 10 and the receiving device 20 are configured different from the typical electronic products. Take a mobile phone or a MP3 player for example, to implement the invention, the mobile phone and the MP 3 player should be first configured as shown in FIG. 2 or FIG. 3 below. After connected by the cable 30, the mobile phone and the MP 3 player can exchange power from each other, of course, the two plugs 31, 32 of the cable 30 should be configured to the mobile phone and the MP 3 player respectively. Since mini-USB ports are an essential port on most portable devices, the ports 31 and 32 could be mini-USB ports.

FIG. 2 is an exemplary block diagram of a first portable device 30 usable in the system of FIG. 1 The portable device 30 can either be used as the providing device 10 or be used as the receiving device 20 in the system of FIG. 1.

When used as the receiving device 20 (shown in FIG. 1), the portable device 30 obtains power from the providing device 10 depicted in FIG. 1 via an input port 38. That is, the portable device 30 is not charged by the AC source but by the providing device 10. The rechargeable battery 41 supplies power for a power-consuming unit 47 inside the portable device.

When used as the providing device 10 (shown in FIG. 1), a rechargeable battery 31 of the portable device 30 should first be charged by the AC source via an AC input port 36 and a rectification circuit 35. Then, the portable device 30 outputs power from the rechargeable battery 31 to the receiving device 20 depicted in FIG. 1 via the output port 33. The power from the rechargeable battery 31 is outputted to a voltage regulator 32 that is controlled by a voltage selector 34. The voltage regulator 45 regulates the power at a desired output voltage selected.

Therefore, when more than one of the portable devices 30 is provided, only one charger dedicated to one of the portable devices 30 is needed, regardless of a function of the portable devices, be it an audio player, mobile phone, and so on. In such a case, the charger replenishes power for the one of the portable devices 30 and the one of the portable devices 30 replenishes power from the AC source. Additionally, when there is no AC source accessible and the rechargeable battery 31 is fully charged or above a certain charged level, the portable device 30 may be used to charge another portable device.

FIG. 3 is an exemplary block diagram of another portable device 40 that can be adopted in the system of FIG. 1. When compared with the portable device 30, the portable device 40 includes a power port 43, a switching unit 48, and a charge/discharge selector 49 instead of the input port 38 and the output port 33 of the portable device 30. The switching unit 48 is controlled by the charge/discharge selector 49. The charge/discharge selector 49 is operable to connect the switching unit 48 with the rechargeable battery 41 or to connect the switching unit 48 with the voltage regulator 42, thus to charge the portable device 40 with power from the providing device 10 or to charge the receiving device 20 from the portable device 40 depicted in FIG. 1.

When used as the receiving device 20 (shown in FIG. 1), the portable device 40 obtains power from the providing device 10 depicted in FIG. 1 via the power port 43. The charge/discharge selector 49 controls the switching unit 48 to connect with the rechargeable battery 41.

When used as the providing device 10 (shown in FIG. 1), the rechargeable battery 41 of the portable device 40 should first be charged by the providing device 10 via the power port 43 or an AC source via an AC input port 46 and a rectification circuit 45. The portable device 40 outputs power from the rechargeable battery 41 to the receiving device 20 depicted in FIG. 1 via the power port 43. The power is outputted to a voltage regulator 42 that is controlled by a voltage selector 44. The voltage regulator 42 regulates the power at a desired output voltage selected. The charge/discharge selector 49 is operable to connect the switching unit 48 with the voltage regulator 42. Thus, the portable device 40 is used to charge the receiving device 20.

Similar to the portable device 30, when more than one of the portable devices 40 is provided, the charger replenishes power for the one of the portable devices 40 and the one of the portable devices 40 replenishes power from the AC source, only one charger dedicated to one of the portable devices 40 is needed, regardless of a function of the portable devices. Also, the portable device 30 and the portable device 40 can be used together, that is, the portable device 30 can charge or be charged by the portable device 40 and the portable device 40 can charge or be charged by the portable device 30 when there is no AC source accessible and the rechargeable battery 31 or 41 is fully charged or above a certain charged level.

As depicted in FIG. 2, the input port 38 and the AC input port 36 can be made into one port when the portable device 30 is not charged by the AC source and charging the receiving device 20 simultaneously. Also, the AC input port 46 and the power port 43 in FIG. 3 can be made into one port when the portable device 40 is not charged by the AC source and charging the receiving device 20 simultaneously.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. A system of supplying power between portable devices comprising:
a power providing portable device and a power receiving portable device, wherein, the power providing portable device comprises a rechargeable battery, a voltage regulator, a voltage selector, and an output port, the voltage regulator is used for regulating power from the rechargeable battery according to the voltage selector and transmitting the power via the output port to the power receiving portable device; the power receiving portable device comprises an input port for receiving power from the providing device and transmitting power to a rechargeable battery of the receiving device.

2. The system according to claim 1 further comprises a cable having a plug at each end, the plugs are connectable to the output port of the providing device and the input port of the receiving device correspondingly.

3. The system according to claim 1, wherein the power providing portable device further comprises an alternating current (AC) input port and a rectification circuit for rectifying power from an AC source via the AC input port and then supplying a direct current to the rechargeable battery.

4. The system according to claim 1, wherein the voltage selector is used for selecting a desired voltage and the voltage regulator is used for regulating the power according to the desired voltage.

5. A portable device comprising:
a rechargeable battery for either receiving power or supplying power;
an output port for outputting the power from the rechargeable battery;
a voltage selector for receiving a voltage selection of a desired output voltage of the portable device; and
a voltage regulator for regulating the power from the rechargeable battery according to the voltage selection before outputting the power via the output port.

6. The portable device according to claim 5, further comprising an input port used for obtaining power to the rechargeable battery.

7. The portable device according to claim 5, further comprising an AC input port and a rectification circuit for rectifying power from an AC source via the AC input port and then supplying a direct current to the rechargeable battery.

8. A portable device comprising:
a rechargeable battery for either receiving power or supplying power;
a voltage regulator for regulating the power from the rechargeable battery;
a power port for connecting with another portable device;
a switching unit for connecting either the rechargeable battery or the voltage regulator to the power port; and
a charge/discharge selector for controlling the switching unit.

9. The portable device according to claim 8, further comprising a voltage selector for receiving a voltage selection of a desired output voltage of the portable device, wherein the voltage selection controlling the voltage regulator to regulate the power from the rechargeable battery.

10. The portable device according to claim 8, further comprising an AC input port and a rectification circuit for rectifying power from an AC source via the AC input port and then supplying a direct current to the rechargeable battery.
